(19) United States
(12) Patent Application Publication
(10) Pub. No.: US 2018/0298853 A1
(43) Pub. Date: Oct. 18, 2018

(54) EGR COOLING APPARATUS

(71) Applicant: AISAN KOGYO KABUSHIKI KAISHA, Obu-shi (JP)

(72) Inventor: Mamoru YOSHIOKA, Nagoya-shi (JP)

(73) Assignee: AISAN KOGYO KABUSHIKI KAISHA, Obu-shi (JP)

(21) Appl. No.: 15/937,957

(22) Filed: Mar. 28, 2018

(30) Foreign Application Priority Data
Apr. 14, 2017 (JP) 2017-080844

(51) Int. Cl. F02M 26/28; F01P 3/12; F01P 7/14; F01P 7/16

(52) U.S. Cl. CPC F02M 26/28; F01P 3/12; F01P 2007/146; F01P 7/167; F01P 7/165; F01P 7/14

(57) ABSTRACT

An EGR cooling apparatus includes a first EGR cooling-water passage (passage parts) to cause cooling water flowing out of an engine to an engine cooling water passage to return to the engine cooling water passage via an EGR cooler; a second EGR cooling-water passage (passage parts) to cause cooling water flowing out of a radiator to the engine cooling water passage to return to the second EGR cooling-water passage via the EGR cooler; a three-way valve for switching a flow of cooling water for the EGR cooler between a first EGR cooling-water passage and a second EGR cooling-water passage; and an electronic control unit (ECU) to control the three-way valve to switch a flow of cooling water to the EGR cooler between the first EGR cooling-water passage during warm-up of the engine and a second EGR cooling-water passage after warm-up.

### CROSS-REFERENCE TO RELATED APPLICATIONS

This application is based upon and claims the benefit of priority from the prior Japanese Patent Application No. 2017-080844 filed on Apr. 14, 2017, the entire contents of which are incorporated herein by reference.

### BACKGROUND

### Technical Field

This disclosure relates to an EGR cooling apparatus configured to cause cooling water that circulates through an engine cooling device to flow to an EGR cooler to thereby cool EGR gas flowing through the EGR cooler.

### Related Art

As the above type of technique, conventionally, there has been known a technique (a cooling water circuit for an EGR cooler) disclosed in Japanese unexamined patent application publication No. 2007-92718 (JP2007-92718A). This technique is configured to cause part of cooling water from an engine cooling water circuit to flow to an EGR cooler provided in an EGR passage to thereby cool EGR gas flowing through the EGR cooler. The engine cooling water circuit is provided with a radiator, a water pump, a first thermostat, and an engine cooling water passage. By operation of the water pump, the cooling water circulates through the engine cooling water passage via an engine, the first thermostat, the radiator, and the water pump. Further, in the engine cooling water passage, a bypass passage which detours around the radiator is provided by branching off from the first thermostat. On the other hand, the cooling water circuit for the EGR cooler is provided with a second thermostat and an EGR cooling water passage. Part of the cooling water that flows through the engine cooling water passage branches off and flows from a portion downstream of the water pump and upstream of the engine to the EGR cooling water passage, then passes the EGR cooler and the second thermostat, and joins together with the cooling water flowing through the engine cooling water passage downstream of the engine and upstream of the first thermostat. In this cooling water circuit for the EGR cooler, when the temperature of cooling water is low during engine warm-up, i.e. while the engine is in a warm-up state, the second thermostat restricts a cooling water flow to the EGR cooler to a slight flow rate. The cooling water in the EGR cooler is heated by EGR gas. This enables a quick increase in the temperature of cooling water, thus suppressing generation of condensed water from the EGR gas. When the temperature of the cooling water is high after engine warm-up, the second thermostat allows the cooling water to flow at a high flow rate to the EGR cooler, thus effectively cooling the EGR gas.

### SUMMARY

### Technical Problem

In the technique disclosed in JP2007-92718A in which a high flow rate of the cooling water flows to the EGR cooler after engine warm-up, the EGR gas can be effectively cooled; however, the temperature of the cooling water becomes higher than that during warm-up. Therefore, at present, there is a limit to the effect that the EGR cooler cools EGR gas after engine warm-up.

Herein, after the engine has completely warmed up, namely, after complete warm-up, the temperature of an engine compartment rises, causing the temperature of an intake manifold to also increase. Thus, the temperature of EGR gas becomes higher than that during warm-up and the density of EGR gas becomes lower than that during warm-up. Accordingly, after complete warm-up, in which EGR is often used in general, the EGR gas density is apt to decrease. Furthermore, when the engine is operated under high load, the intake-air pressure in an intake passage is almost equal to atmospheric pressure. Therefore, even if the flow passage cross-sectional area of an EGR valve is designed to be large, the EGR flow rate of EGR gas allowed to pass through the EGR valve is scarcely able to be increased. This makes it hard to increase an EGR rate.

The present disclosure has been made to address the above problems and has a purpose to provide an EGR cooling apparatus capable of increasing an EGR gas density in order to increase an EGR rate after engine warm-up.

### Means of Solving the Problem

To achieve the above-mentioned purpose, one aspect of the present disclosure provides an EGR cooling apparatus provided with an EGR cooler and configured to cause a cooling water that circulates through an engine cooling device for cooling an engine to flow to the EGR cooler to cool EGR gas flowing through the EGR cooler, wherein the engine cooling device includes a radiator, an engine-side water pump, and an engine cooling water passage, the engine cooling device is configured to operate the engine-side water pump to cause the cooling water to circulate through the engine cooling water passage via the engine, the radiator, and the engine-side water pump, the engine, the radiator, and the EGR cooler each include a water inlet for inflow of the cooling water and a water outlet for outflow of the cooling water, and the EGR cooling apparatus includes: a first EGR cooling-water passage configured to allow the cooling water flowing out from the water outlet of the engine to the engine cooling water passage to return to the engine cooling water passage via the EGR cooler; a second EGR cooling-water passage configured to allow the cooling water flowing out from the water outlet of the radiator to the engine cooling water passage to return to the engine cooling water passage via the EGR cooler; a flow switching unit configured to switch a flow of the cooling water for the EGR cooler between the first EGR cooling-water passage and the second EGR cooling-water passage; and a control unit configured to control the flow switching unit to switch the flow of the cooling water for the EGR cooler to the first EGR cooling-water passage when the engine is in a state during warm-up and switch the flow of the cooling water to the second EGR cooling-water passage when the engine is in a state after warm-up.

According to the present disclosure, it is possible to increase an EGR gas density in order to increase an EGR rate after engine warm-up.

### BRIEF DESCRIPTION OF THE DRAWING

FIG. 1 is a schematic configuration diagram of a gasoline engine system in a first embodiment;

FIG. 2 is a flowchart showing contents of EGR cooling control in the first embodiment;

FIG. 3 is a schematic diagram showing a flow (a flow direction) of cooling water in an engine cooling device and an EGR cooling apparatus when radiator cooling is executed in the first embodiment;

FIG. 4 is a schematic diagram showing a flow (a flow direction) of cooling water in the engine cooling device and the EGR cooling apparatus when engine cooling is executed in the first embodiment;

FIG. 5 is a schematic configuration diagram of a gasoline engine system in a second embodiment;

FIG. 6 is a flowchart showing contents of EGR cooling control in the second embodiment;

FIG. 7 is an outside-air temperature correction map to be referred to for obtaining an outside-air correction value according to an outside-air temperature in the second embodiment;

FIG. 8 is an intake-air amount correction map to be referred to for obtaining an intake-air amount correction value according to an average intake-air amount in the second embodiment;

FIG. 9 is a schematic diagram showing a flow (a flow direction) of cooling water in an engine cooling device and an EGR cooling apparatus when radiator cooling is executed in the second embodiment; and

FIG. 10 is a schematic diagram showing a flow (a flow direction) of cooling water in the engine cooling device and the EGR cooling apparatus when engine cooling is executed in the second embodiment.

### DETAILED DESCRIPTION OF THE EXEMPLARY EMBODIMENTS

### First Embodiment

A detailed description of a first embodiment of an EGR cooling apparatus of the present disclosure, applied to a gasoline engine system which is one of typical embodiments of this disclosure, will now be given referring to the accompanying drawings.

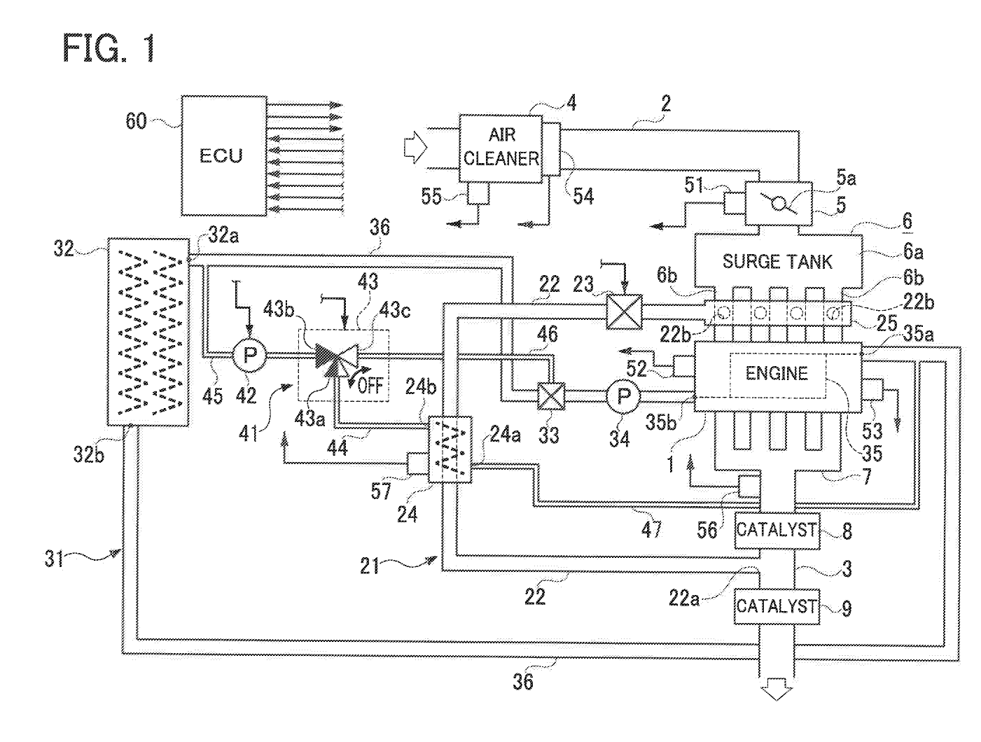

FIG. 1 is a schematic configuration diagram showing a gasoline engine system in the present embodiment. The gasoline engine system mounted in a vehicle includes an engine 1. This engine 1 is a 4-cycle reciprocating engine, which includes well-known parts or components such as a piston and a crank shaft. The engine 1 is provided with an intake passage 2 through which intake air is delivered to each cylinder and an exhaust passage 3 through which exhaust gas is exhausted from each cylinder. In the intake passage 2, there are provided an air cleaner 4, a throttle device 5, and an intake manifold 6, which are arranged in this order from an upstream side of the intake passage 2. The throttle device 5 is an electrically-operated valve that can operate a butterfly throttle valve 5a with a variable opening degree in response to an accelerator operated by a driver. The throttle device 5 is a device for adjusting an intake-air amount in the intake passage 2. The intake manifold 6 includes a surge tank 6a and four branch passages 6b branching off from the surge tank 6a to each corresponding cylinder of the engine 1. In the exhaust passage 3, there are provided an exhaust manifold 7, a first catalyst 8, and a second catalyst 9, which are arranged in this order from an upstream side of the exhaust passage 3. Those catalysts 8 and 9 are used to clean up exhaust gas and each consist of a three-way catalyst.

The engine 1 is provided with a fuel injection device (not shown) to inject fuel into each corresponding cylinder. The fuel injection device is configured to inject the fuel supplied from a fuel supply device (not shown) to each cylinder of the engine 1. In each cylinder, the fuel injected from the fuel injection device and intake air introduced from the intake manifold 6 are mixed with each other, forming a combustible air-fuel mixture.

The engine 1 is further provided with an ignition device (not shown) for each cylinder. Each ignition device is configured to ignite the combustible air-fuel mixture in each corresponding cylinder. The combustible air-fuel mixture in each cylinder is exploded and burnt by an ignition operation of the ignition device and, after burning, the resultant exhaust gas is discharged from each cylinder to the outside air by passing through the exhaust manifold 7, the first catalyst 8, and the second catalyst 9. At that time, a piston (not shown) in each cylinder moves up and down, rotating a crank shaft (not shown), thereby generating power in the engine 1.

The gasoline engine system in the present embodiment is provided with an exhaust recirculation device (an EGR device) 21. This EGR device 21 is provided with an exhaust gas recirculation passage (an EGR passage) 22 for allowing part of exhaust gas discharged from each cylinder to the exhaust passage 3 to flow as an exhaust recirculation gas (an EGR gas) to the intake passage 2 and then return to each cylinder, an exhaust gas recirculation valve (an EGR valve) 23 placed in the EGR passage 22 and configured to adjust a flow rate of the EGR gas, and an EGR cooler 24 configured to cool the EGR gas that flows through the EGR passage 22. The EGR passage 22 includes an inlet 22a and a plurality of outlets 22b. The inlet 22a of the EGR passage 22 is connected to the exhaust passage 3 between the two catalysts 8 and 9. The outlets 22b of the EGR passage 22 are each connected to the intake passage 2 (the intake manifold 6) downstream of the throttle device 5 via a gas distribution pipe 25. Those outlets 22b of the EGR passage 22 are arranged in the gas distribution pipe 25. The outlets 22b are individually connected to the corresponding branch passages 6b to uniformly distribute EGR gas to the branch passages 6b.

In the present embodiment, the EGR valve 23 consists of an electrically-operated valve having a variable opening degree. This EGR valve 23 preferably has high flow rate, high response, and high resolution characteristics. In the present embodiment, as the structure of the EGR valve 23, for example, a “double eccentric valve” disclosed in Japanese Patent No. 5759646 may be adopted. This double eccentric valve is configured to address high flow control. Furthermore, the EGR cooler 24 has a well-known structure including a gas passage for allowing EGR gas to flow therethrough and a heat-exchanger placed in that gas passage and for allowing cooling water to flow therethrough.

The gasoline engine system in the present embodiment is provided with a water-cooling type engine cooling device 31 for cooling the engine 1. The engine cooling device 31 is provided with a radiator 32 which is a heat exchanger, a thermostat 33 for adjusting a flow rate of cooling water according to the temperature of cooling water, an engine-side water pump 34, a water jacket 35 provided inside the engine 1, and an engine cooling water passage 36. The engine-side water pump 34 is a water pump located on a side of the engine cooling device 31, closer to the engine 1 relative to an opposite side closer to the radiator 32. The engine cooling device 31 is configured to operate the engine-side water pump 34 to cause the cooling water to circulate through the engine cooling water passage 36 via the radiator 32, the thermostat 33, the engine-side water pump 34, and the water jacket 35 of the engine 1. The water jacket 35 of the engine 1 includes a water inlet 35b for inflow of the cooling water and a water outlet 35a for outflow of the cooling water. The radiator 32 includes a water inlet 32b for inflow of the cooling water and a water outlet 32a for outflow of the cooling water. The radiator 32 is placed on the front of a vehicle and configured to cool the cooling water by receiving running air. The thermostat 33 is configured to open and close the engine cooling water passage 36 by sensing the temperature of cooling water in order to keep the temperature of cooling water at a required temperature. The engine-side water pump 34 is configured to operate in synchronization with the operation of the engine 1. In addition, the engine cooling water passage 36 is provided with a bypass passage (not shown) branching off from the thermostat 33 to detour around the radiator 32.

The gasoline engine system in the present embodiment is provided with an EGR cooling apparatus 41 configured to cause the cooling water that circulates through the engine cooling device 31 to flow to the EGR cooler 24 to thereby cool the EGR gas flowing through the EGR cooler 24. The EGR cooling apparatus 41 is provided with the EGR cooler 24 and further a compact electrically-operated radiator-side water pump 42, a single electrically-operated three-way valve 43, a first EGR cooling-water passage which will be mentioned later, and a second EGR cooling-water passage which will be mentioned later. The radiator-side water pump 42 is a water pump located on a side of the EGR cooling apparatus 41, closer to the radiator 32 relative to an opposite side closer to the engine 1. The EGR cooler 24 includes a water inlet 24a for inflow of cooling water and a water outlet 24b for outflow of cooling water.

In the present embodiment, the three-way valve 43 corresponds to one example of a flow switching unit in the present disclosure to switch a flow (i.e. a flow direction) of cooling water for the EGR cooler 24 between the first EGR cooling-water passage and the second EGR cooling-water passage. This three-way valve 43 is provided with a first port 43a, a second port 43b, and a third port 43c. When the three-way valve 43 is turned to an ON state, the first port 43a and the second port 43b are communicated with each other, while the first port 43a and the third port 43c are shut off from each other. On the other hand, when the three-way valve 43 is turned to an OFF state, the first port 43a and the second port 43b are shut off from each other, while the first port 43a and the third port 43c are communicated with each other. The first port 43a of the three-way valve 43 and the water outlet 24b of the EGR cooler 24 are connected through a first passage part 44. The second port 43b of the three-way valve 43 and a portion of the passage 36 near the water outlet 32a of the radiator 32 are connected through a second passage part 45. The third port 43c of the three-way valve 43 and the thermostat 33 are connected through a third passage part 46. A portion of the passage 36 near the water outlet 35a of the water jacket 35 and the water inlet 24a of the EGR cooler 24 are connected through a fourth passage part 47.

The first EGR cooling-water passage is a flow channel configured to allow cooling water flowing out from the water outlet 35a of the water jacket 35 of the engine 1 to the engine cooling water passage 36 to return to the engine cooling water passage 36 through the EGR cooler 24. In the present embodiment, the first EGR cooling-water passage is constituted of the first passage part 44, the third passage part 46, and the fourth passage part 47. On the other hand, the second EGR cooling-water passage is a flow channel configured to allow cooling water flowing out from the water outlet 32a of the radiator 32 to the engine cooling water passage 36 to return to the engine cooling water passage 36 through the EGR cooler 24. In the present embodiment, the second EGR cooling-water passage is constituted of the first passage part 44, the second passage part 45, and the fourth passage part 47.

Next, one example of an electric structure of the foregoing gasoline engine system will be described below. In FIG. 1, various types of sensors 51 to 57 provided in this gasoline engine system correspond to one example of an operating state detection unit configured to detect an operating state of the engine 1. A throttle sensor 51 provided in the throttle device 5 detects an opening degree (a throttle opening degree) TA of the throttle valve 5a and outputs an electric signal representing a detected value thereof. An engine water temperature sensor 52 provided in the engine 1 detects a temperature (engine cooling water temperature) THW of the cooling water flowing through the inside of the engine 1 and outputs an electric signal representing a detected value thereof. A rotational speed sensor 53 provided in the engine 1 detects a rotational speed (engine rotational speed) NE of a crank shaft and outputs an electric signal representing a detected value thereof. An air flow meter 54 provided in the air cleaner 4 detects an intake-air amount Ga of intake air flowing through the intake passage 2 through the air cleaner 4 and outputs an electric signal representing a detected value thereof. An intake-air temperature sensor 55 provided at an inlet of the air cleaner 4 detects a temperature (outside temperature) THA of outside air to be sucked into the air cleaner 4 and outputs an electric signal representing a detection value thereof. An oxygen sensor 56 provided in the exhaust passage 3 upstream of the first catalyst 8 detects an oxygen concentration Ox in exhaust gas and outputs an electric signal representing a detected value thereof. An EGR water temperature sensor 57 provided in the EGR cooler 24 detects a temperature (EGR cooling water water temperature) THE of the cooling water flowing through the EGR cooler 24 and outputs an electric signal representing a detected value thereof. In the present embodiment, the engine water temperature sensor 52, the air flow meter 54, the intake-air temperature sensor 55, and the EGR water temperature sensor 57 correspond to one example of a warm-up state detecting unit of the present disclosure.

This gasoline engine system is further provided with an electronic control unit (ECU) 60 responsible for control of the gasoline engine system. This ECU 60 is connected to each of the various types of sensors 51 to 57. Furthermore, the ECU 60 is connected to the EGR valve 23, the radiator-side water pump 42 and the three-way valve 43 and further to a fuel injection device (not shown) and an ignition device (not shown). The ECU 60 corresponds to one example of a control unit of the present disclosure. The ECU 60 is provided with a central processing unit (CPU), various memories, an external input circuit, an external output circuit, and others. The memory stores a predetermined control program related to various controls. The CPU is configured to execute fuel injection control, ignition timing control, EGR control, EGR cooling control, and others based on the predetermined control program in response to a detection signal transmitted from the various sensors 51 to 57 through the input circuit.

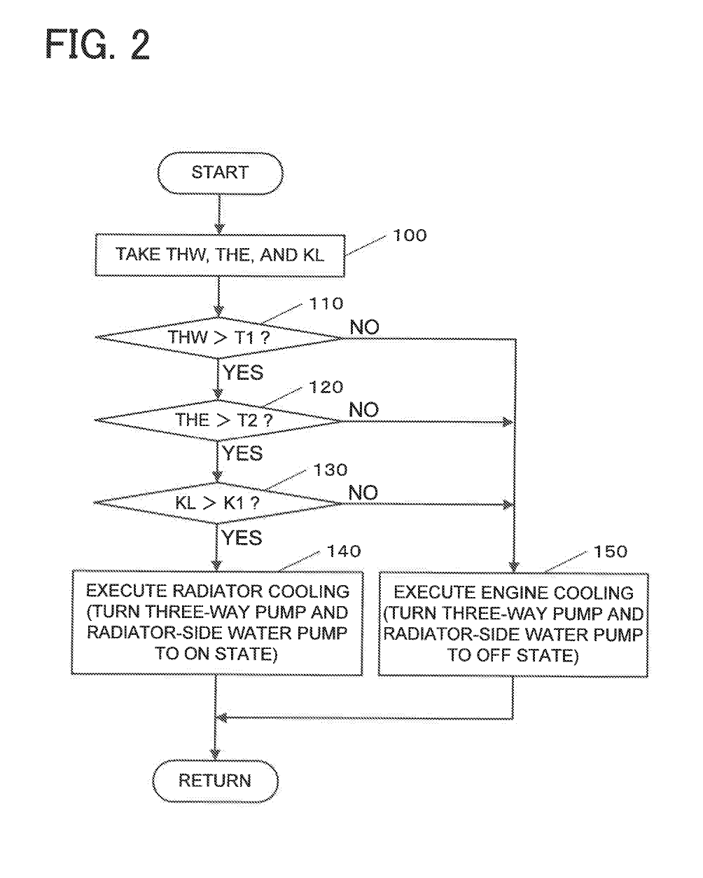

Next, the EGR cooling control in the present embodiment will be described below. FIG. 2 is a flowchart showing contents of the control.

When the processing shifts to this routine, in step 100, the ECU 60 takes the engine cooling water temperature THW, the EGR cooling water temperature THE, and an engine load KL based on detection values of the engine water temperature sensor 52, the EGR water temperature sensor 57, and others. The ECU 60 can obtain the engine load KL from the throttle opening degree TA and the engine rotational speed NE.

In step 110, successively, the ECU 60 determines whether or not the engine cooling water temperature THW is higher than a predetermined value T1. This predetermined value T1 can be assigned for example “85° C.”. When YES in step 110, the ECU 60 advances the processing to step 120. When NO in step 110, the ECU 60 shifts the processing to step 150.

In step 120, the ECU 60 determines whether or not the EGR cooling water temperature THE is higher than a predetermined value T2 (T2<T1). This predetermined value T2 can be assigned for example “65° C.”. When YES in step 120, the ECU 60 advances the processing to step 130. When NO in step 120, the ECU 60 shifts the processing to step 150.

In step 130, the ECU 60 determines whether or not the engine load KL is higher than a predetermined value K1. This predetermined value K1 can be assigned for example “40%”, a maximum of which is 100%. When YES in step 130, the ECU 60 advances the processing to step 140 to perform a radiator cooling operation (hereinafter, simply referred to as “radiator cooling”). When NO in step 130, the ECU 60 shifts the processing to step 150 to execute an engine cooling operation (hereinafter, simply referred to as “engine cooling”). In the present embodiment, the radiator cooling is an operation or control for cooling the EGR gas by utilizing the cooling water flowing out of the radiator and the engine cooling is an operation for cooling the EGR gas by utilizing the cooling water flowing out of the engine.

Herein, the engine cooling is executed when the engine load KL is equal to or less than the predetermined value K1 is for the following reasons. When the engine 1 is under light load, the negative pressure remains in the intake passage 2 downstream of the throttle device 5. Further, during the light load, raising the EGR gas temperature by the engine cooling enables improvement of the combustion performance of the engine 1.

In step 140, subsequently, the radiator cooling is executed. Concretely, the ECU 60 turns both the three-way valve 43 and the radiator-side water pump 42 to an ON state to cool the EGR cooler 24 with the cooling water that flows out of the radiator 32, this cooling water having a relatively low temperature. Then, the ECU 60 returns the processing to step 100. Herein, since the cooling water is cooled by the radiator 32, the cooling water flowing out of the radiator 32 is lower in temperature than the cooling water that does not pass through the radiator 32.

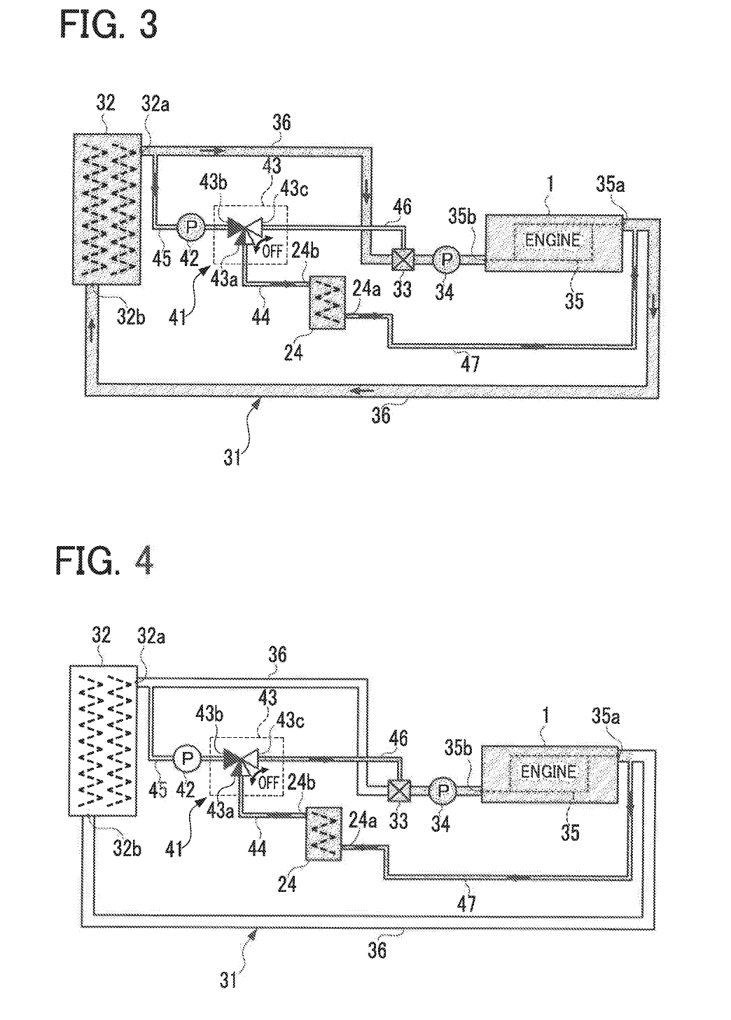

FIG. 3 is a schematic configuration diagram showing a flow (a flow direction) of cooling water in the engine cooling device 31 and the EGR cooling apparatus 41 when the radiator cooling is executed. In FIG. 3, a shaded area with dots represents a zone in which the cooling water flows, and arrows indicate a flow direction. In the engine cooling device 31, as shown in FIG. 3, the cooling water flowing out of the engine 1 (the water jacket 35) into the engine cooling water passage 36 returns to the engine 1 (the water jacket 35) by passing through the radiator 32, the thermostat 33, and the engine-side water pump 34. Thus, the cooling water circulates through this path. Further, part of the cooling water flowing out of the radiator 32 returns to the engine cooling water passage 36 near the water outlet 35a of the engine 1 by passing through the second passage part 45, the radiator-side water pump 42, the three-way valve 43, the first passage part 44, the EGR cooler 24, and the fourth passage part 47. Accordingly, the cooling water cooled to a relatively low temperature by the radiator 32 flows in the EGR cooler 24 to cool EGR gas flowing through the EGR cooler 24 to a low temperature.

On the other hand, in step 150 following the step 110, 120, or 130, the ECU 60 executes the engine cooling. Concretely, the ECU 60 turns both the three-way valve 43 and the radiator-side water pump 42 to an OFF state to cool the EGR cooler 24 with the cooling water that flows out of the engine 1. Thereafter, the ECU 60 returns the processing to step 100. At that time, the cooling water does not flow through the radiator 32 and thus the cooling water flowing out of the engine 1 has a higher temperature than the cooling water flowing through the radiator 32.

FIG. 4 is a schematic configuration diagram showing a flow (a flow direction) of the cooling water in the engine cooling device 31 and the EGR cooling apparatus 41 when the engine cooling is executed. In FIG. 4, a shaded area with dots represents a zone in which the cooling water flows, and arrows indicate a flow direction. In the engine cooling device 31, as shown in FIG. 4, the cooling water flowing out of the engine 1 (the water jacket 35) to the engine cooling water passage 36 does not flow to the radiator 32, but passes through the fourth passage part 47, the EGR cooler 24, the first passage part 44, the three-way valve 43, the third passage part 46, and the thermostat 33 and then returns to the engine cooling water passage 36 near the engine-side water pump 34. Accordingly, the cooling water relatively high in temperature flows in the EGR cooler 24, so that excessive cooling of the EGR gas flowing through the EGR cooler 24 is suppressed.

According to the foregoing control, the ECU 60 is configured to control the three-way valve 43 and the radiator-side water pump 42 to switch the flow of cooling water for the EGR cooler 24 to the first EGR cooling-water passage when the engine 1 is in a state during warm-up (a “during warm-up state”) and switch the flow of cooling water for the EGR cooler 24 to the second EGR cooling-water passage when the engine 1 is in a state after warm-up (an “after warm-up state”). To be specific, the ECU 60 is configured to turn the three-way valve 43 and the radiator-side water pump 42 to an OFF state to cause the cooling water flowing out from the water outlet 35a of the engine 1 (the water jacket 35) to the engine cooling water passage 36 to flow through the first EGR cooling-water passage via the EGR cooler 24 and the three-way valve 43 and return to the engine cooling water passage 36 near the engine-side water pump 34. Further, the ECU 60 is configured to turn the three-way valve 43 and the radiator-side water pump 42 to an ON state to cause the cooling water flowing out from the water outlet 32a of the radiator 32 to the engine cooling water passage 36 to flow through the second EGR cooling-water passage via the EGR cooler 24 and return to the engine cooling water passage 36 near the water outlet 35a of the engine 1 (the water jacket 35).

According to the EGR cooling apparatus 41 in the present embodiment described as above, the temperature of cooling water flowing out from the water outlet 32a of the radiator 32 has a relatively low temperature as compared with the temperature of cooling water flowing out from the water outlet 35a of the engine 1 (the water jacket 35). Further, the temperature of cooling water flowing out from the water outlet 35a of the engine 1 in the during warm-up state of the engine 1 is usually relatively lower than that in the after warm-up state of the engine 1. Herein, the cooling water flowing out from the water outlet 35a of the engine 1 passes through the first EGR cooling-water passage (each passage part 44, 46, and 47) and flows to the EGR cooler 24. The cooling water flowing out from the water outlet 32a of the radiator 32 passes through the second EGR cooling-water passage (each passage part 44, 45, and 47) and flows to the EGR cooler 24. The ECU 60 then switches the flow of cooling water for the EGR cooler 24 to the first EGR cooling-water passage when the engine 1 is in the during warm-up state and switches it to the second EGR cooling-water passage when the engine 1 is in the after warm-up state. Therefore, during warm-up of the engine 1, the relatively low-temperature cooling water flows to the EGR cooler 24 through the first EGR cooling-water passage. After warm-up of the engine 1, the relatively low temperature cooling water flows to the EGR cooler 24 through the second EGR cooling-water passage. For this purpose, during warm-up of the engine 1, the relatively low temperature cooling water can cool the EGR gas and also enhance the EGR gas density to increase an EGR rate. During warm-up of the engine 1, furthermore, the relatively low temperature cooling water can effectively cool the EGR gas and enhance the EGR gas density to increase an EGR rate. Therefore, even after warm-up of the engine 1 where EGR is used at high frequencies, the EGR gas density can be raised to increase an EGR flow rate (an EGR rate) of the EGR gas passing through the EGR valve 23. This can enhance exhaust emission and drivability of the engine 1.

Specifically, according to the EGR cooling apparatus 41 in the present embodiment, after warm-up, the cooling water flowing out from the water outlet 32a of the radiator 32 in the engine cooling device 31, which is lower in temperature than the cooling water flowing out from the water outlet 35a of the engine 1, is delivered to the EGR cooler 24 to cool the EGR gas flowing through the EGR cooler 24. Accordingly, even after warm-up of the engine 1, the temperature of EGR gas is decreased and thus the EGR gas density is increased. Therefore, the EGR rate can be increased during high-load operation of the engine 1 (i.e. while the intake air pressure is nearly zero, making the EGR gas less likely to enter the intake passage 2). This can increase the EGR rate without causing an increase in size of the EGR valve 23 or causing a lowered pressure drop of the EGR cooler 24 (increasing a size, increasing a cost).

According to the configuration of the present embodiment, the cooling water flowing out from the water outlet 35a of the engine 1 and the cooling water flowing out from the water outlet 32a of the radiator 32 are selectively caused to flow to the the EGR cooler 24 by use of the single three-way valve 43. Thus, the structure for switching a flow of cooling water for the EGR cooler 24 can be simplified.

According to the configuration of the present embodiment, when a flow of cooling water to be directed to the EGR cooler 24 is to be switched over to the second EGR cooling-water passage, the ECU 60 turns the radiator-side water pump 42 to an ON state. Therefore, the cooling water flowing out of the radiator 32 is pressure-fed to the EGR cooler 24 through the second EGR cooling-water passage. This enables the relatively low-temperature cooling water flowing out of the radiator 32 to efficiently flow to the EGR cooler 24.

According to the configuration of the present embodiment, the ECU 60 determines whether the engine 1 is in the during warm-up state or in the after warm-up state based on detection results of the engine water temperature sensor 52 and the EGR water temperature sensor 57. Thus, the engine 1 is precisely determined to be in the state after warm-up and a flow of cooling water for the EGR cooler 24 is switched over to the second EGR cooling-water passage. Accordingly, after warm-up of the engine 1, the EGR gas can be appropriately and reliably cooled with the relatively low-temperature cooling water flowing out of the radiator 32.

### Second Embodiment

A detailed description of a second embodiment of an EGR cooling apparatus of the present disclosure, applied to a gasoline engine system will be given referring to the accompanying drawings.

In the following description, similar or identical parts to those in the first embodiment are assigned the same reference signs as those in the first embodiment. The following explanation is thus given with a focus on differences from the first embodiment.

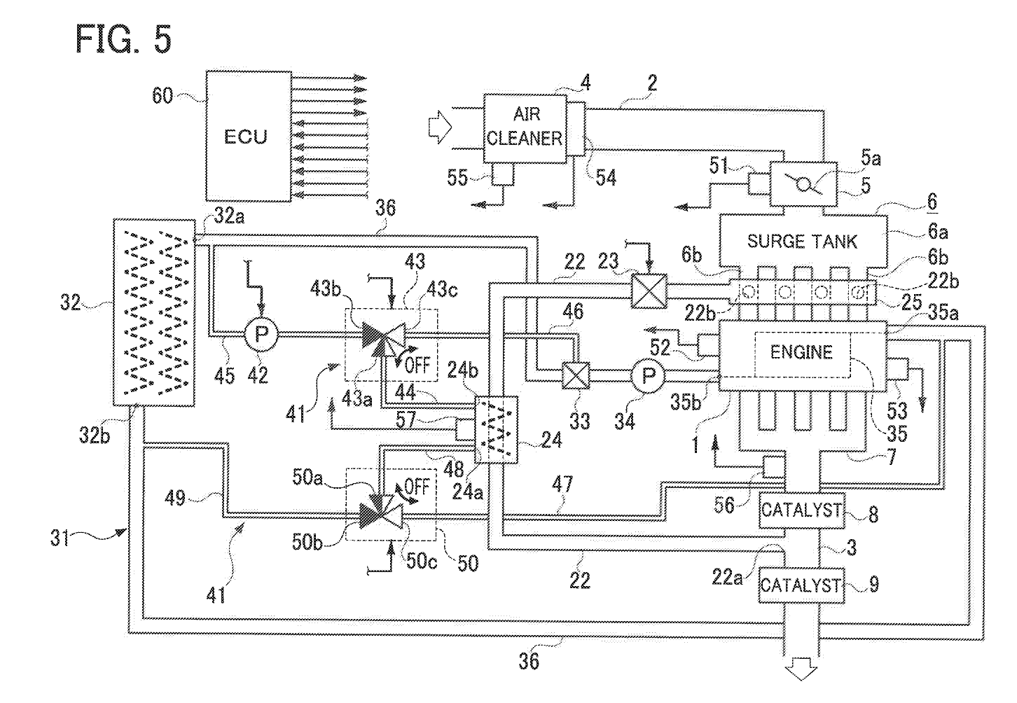

The present embodiment differs from the first embodiment in the structure of the EGR cooling apparatus 41 and the contents of the EGR cooling control. FIG. 5 is a schematic configuration diagram showing a gasoline engine system in the present embodiment. As shown in FIG. 5, the EGR cooling apparatus 41 is provided with a compact radiator-side water pump 42 which is electrically operated, a first three-way valve 43 and a second three-way valve 50 which are electrically operated, and first, second, third, fourth, fifth, and sixth passage parts 44, 45, 46, 47, 48, and 49. In the present embodiment, the EGR cooler 24, the radiator-side water pump 42, the first three-way valve 43, and the first to fourth passage parts 44 to 47 are identical to those in the first embodiment. The second three-way valve 50 is provided with a first port 50a, a second port 50b, and a third port 50c. When this second three-way valve 50 is turned to an ON state, the first port 50a and the second port 50b are communicated with each other, while the first port 50a and the third port 50c are shut off from each other. On the other hand, when the second three-way valve 50 is turned to an OFF state, the the first port 50a and the second port 50b are shut off from each other, while the first port 50a and the third port 50c are communicated with each other. In the present embodiment, the fourth passage part 47 extending from a portion of the engine cooling water passage 36 near the water outlet 35a of the water jacket 35 is connected to the third port 50c of the second three-way valve 50. Further, the first port 50a of the second three-way valve 50 and the water inlet 24a of the EGR cooler 24 are connected through the fifth passage part 48. In addition, a portion of the engine cooling water passage 36 near the water inlet 32b of the radiator 32 and the second port 50b of the second three-way valve 50 are connected through the sixth passage part 49. The second three-way valve 50 is also connected to the ECU 60 and controlled by the ECU 60. In the present embodiment, the first EGR cooling-water passage is constituted of the first passage part 44, the third to fifth passage parts 46 to 48. The second EGR cooling-water passage is constituted of the first passage part 44, the second passage part 45, the fifth passage part 48, and the sixth passage part 49. In the present embodiment, moreover, the first three-way valve 43 and the second three-way valve 50 correspond to one example of a flow switching unit of the present disclosure.

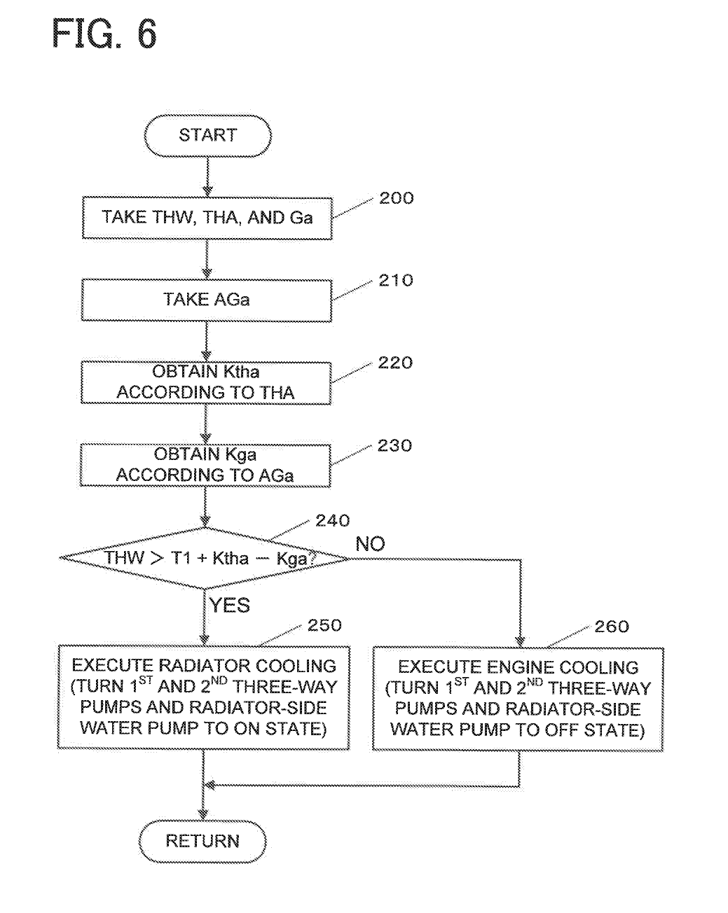

Next, the EGR cooling control in the present embodiment will be described in detail below. FIG. 6 is a flowchart showing contents of the control.

When the processing is shifted to this routine, in step 200, the ECU 60 takes an engine cooling water temperature THW, an outside-air temperature THA, and an intake-air amount Ga based on detection values of the engine water temperature sensor 52, the intake air temperature sensor 55, and the air flow meter 54.

In step 210, the ECU 60 takes an average intake-air amount AGa. The ECU 60 can obtain the average intake-air amount AGa by calculating an average value of data on the intake-air amounts Ga taken before this time.

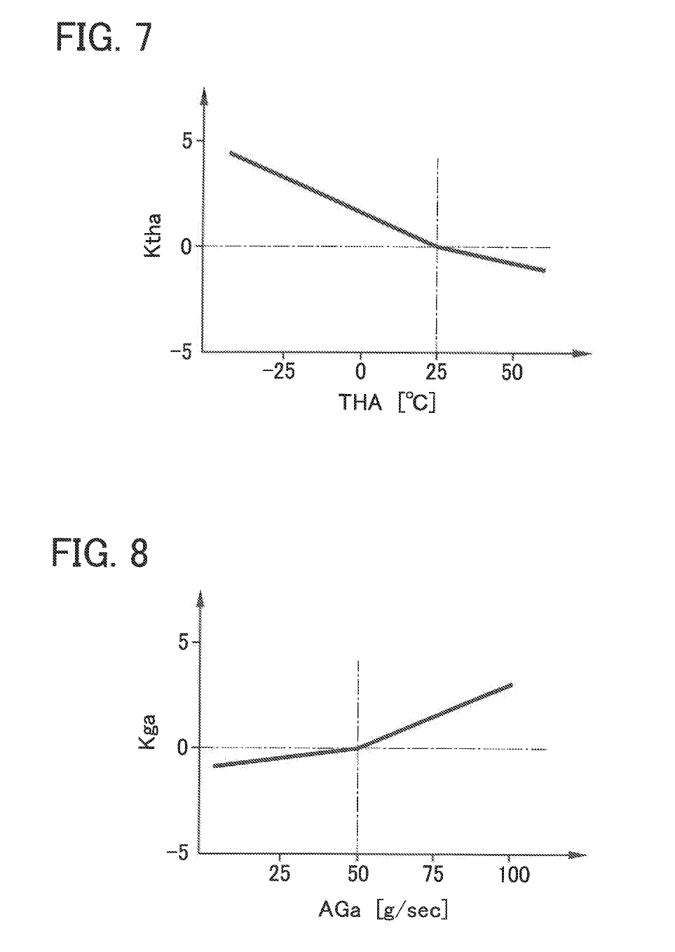

In step 220, the ECU 60 obtains an outside-air temperature correction value Ktha according to the outside-air temperature THA in relation to the engine cooling water temperature THW. The ECU 60 can obtain this outside-air temperature correction value Ktha according to the outside-air temperature THA by referring to for example an outside-air temperature correction map as shown in FIG. 7. This outside-air temperature correction map is set such that the outside-air temperature correction value Ktha increases from 0 toward 5 as the outside-air temperature THA decreases from 25° C. toward a low temperature side, while the outside-air correction value Ktha decreases from 0 toward −1 as the outside-air temperature THA increases from 25° C. toward a high temperature side. This map enables determination of the outside-air temperature correction value Ktha by which the engine cooling water temperature THW can be corrected to increase as the outside-air temperature THA decreases. Since the cooling water in the radiator 32 is apt to be excessively cooled as the outside-air temperature THA is lower, the engine cooling water temperature THW is corrected to a high temperature side by the outside-air temperature correction value Ktha.

In step 230, the ECU 60 obtains an intake-air amount correction value Kga according to the average intake-air amount AGa in relation to the engine cooling water temperature THW. The ECU 60 can obtain this intake-air amount correction value Kga according to the average intake-air amount AGa by referring to for example an intake-air amount correction map as shown in FIG. 8. This intake-air amount correction map is set such that, the intake-air amount correction value Kga decreases from 0 toward −1 as the average intake-air amount AGa decreases from 50 (g/sec), while the intake-air amount correction value Kga increases from 0 toward 3 as the average intake-air amount AGa increases from 50 (g/sec). This map enables determination of the intake-air amount correction value Kga by which the engine cooling water temperature THW can be corrected to decrease as the average intake-air amount AGa increases.

In step 240, subsequently, the ECU 60 determines whether or not the engine cooling water temperature THW is higher than a calculation value obtained by adding the outside-air correction value Ktha to a predetermined value T1 and also subtracting the intake-air amount correction value Kga therefrom. This predetermined value T1 can be assigned for example “85° C.”. When YES in step 240, the ECU 60 advances the processing to step 250 to execute the radiator cooling. When NO in step 240, the ECU 60 shifts the processing to step 260 to execute the engine cooling.

In step 250, the radiator cooling is executed. Specifically, the ECU 60 turns the first three-way valve 43, the second three-way valve 50, and the radiator-side water pump 42 to an ON state to cool the EGR cooler 24 with the relatively low-temperature cooling water flowing out of the radiator 32. Thereafter, the ECU 60 returns the processing to step 200. At that time, the cooling water is also cooled by the radiator 32, so that the cooling water flowing out of the radiator 32 is lower in temperature than the cooling water that does not pass through the radiator 32.

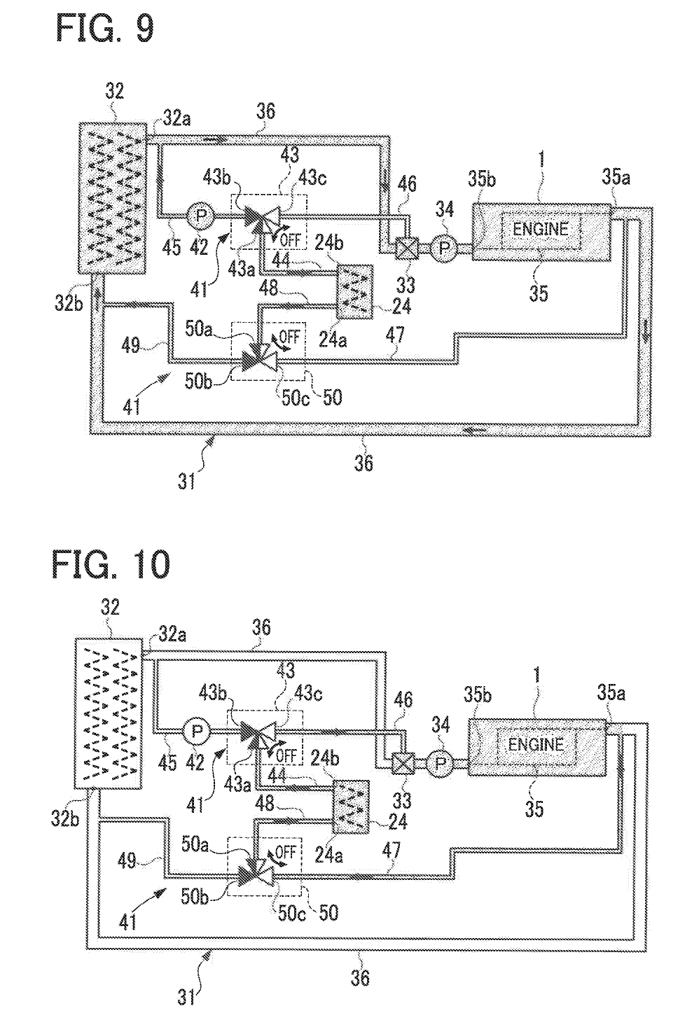

FIG. 9 is a schematic configuration diagram showing a flow (a flow direction) of cooling water in the engine cooling device 31 and the EGR cooling apparatus 41 when the radiator cooling is executed. As shown in FIG. 9, in the engine cooling device 31, the cooling water flowing out of the engine 1 (the water jacket 35) to the engine cooling water passage 36 returns to the engine 1 (the water jacket 35) through the radiator 32, the thermostat 33, and the engine-side water pump 34. The cooling water circulates through this path. Further, part of the cooling water flowing out of the radiator 32 returns to the engine cooling water passage 36 near the water inlet 32b of the radiator 32 through the second passage 45, the radiator-side water pump 42, the first three-way valve 43, the first passage part 44, the EGR cooler 24, the fifth passage part 48, the second three-way valve 50, and the sixth passage part 49. Accordingly, the cooling water cooled to a relatively low temperature by the radiator 32 flows in the EGR cooler 24 to cool the EGR gas flowing through the EGR cooler 24 to a low temperature.

In step 260, on the other hand, the ECU 60 executes the engine cooling. Concretely, the ECU 60 turns all the first three-way valve 43, the second three-way valve 50, and the radiator-side water pump 42 to an OFF state to cool the EGR cooler 24 with the cooling water that flows out of the engine 1. Thereafter, the ECU 60 returns the processing to step 200. At that time, the cooling water also does not flow through the radiator 32 and thus the cooling water flowing out of the engine 1 has a higher temperature than the cooling water flowing through the radiator 32.

FIG. 10 is a schematic configuration diagram showing a flow (a flow direction) of cooling water in the engine cooling device 31 and the EGR cooling apparatus 41 when the engine cooling is executed. As shown in FIG. 10, in the engine cooling device 31, the cooling water flowing out of the engine 1 (the water jacket 35) to the engine cooling water passage 36 does not flow to the radiator 32, but passes through the fourth passage part 47, the second three-way valve 50, the fifth passage part 48, the EGR cooler 24, the first passage part 44, the first three-way valve 43, the third passage part 46, and the thermostat 33 and then returns to the engine cooling water passage 36 near the engine-side water pump 34. Accordingly, the cooling water relatively high in temperature flows in the EGR cooler 24, so that excessive cooling of the EGR gas flowing through the EGR cooler 24 is suppressed.

According to the foregoing control, the ECU 60 is configured to control the first three-way valve 43, the second three-way valve 50, and the radiator-side water pump 42 to switch the flow of cooling water for the EGR cooler 24 to the first EGR cooling-water passage when the engine 1 is in the during warm-up state and switch the flow of cooling water for the EGR cooler 24 to the second EGR cooling-water passage when the engine 1 is in the after warm-up state. To be specific, the ECU 60 is configured to turn the first three-way valve 43, the second three-way valve 50, and the radiator-side water pump 42 to an OFF state to cause the cooling water flowing out from the water outlet 35a of the engine 1 (the water jacket 35) to the engine cooling water passage 36 to flow through the first EGR cooling-water passage via the second three-way valve 50, the EGR cooler 24, and the first three-way valve 43, and then return to the engine cooling water passage 36 near the engine-side water pump 34. Further, the ECU 60 is configured to turn the first three-way valve 43, the second three-way valve 50, and the radiator-side water pump 42 to an ON state to cause the cooling water flowing out from the water outlet 32a of the radiator 32 to flow through the second EGR cooling-water passage via the first three-way valve 43, the EGR cooler 24, and the second three-way valve 50 and then return to the engine cooling water passage 36 near the water inlet 32b of the radiator 32.

According to the EGR cooling apparatus 41 in the present embodiment described as above, the operations and advantages equal to those in the first embodiment can be achieved. In addition, according to the structure of the present embodiment, differing from the first embodiment, when the cooling water flowing out from the water outlet 32a of the radiator is caused to flow to the EGR cooler 24, the cooling water circulates between the EGR cooler 24 and the radiator 32 via the the first three-way valve 43, the second three-way valve 50, and the second EGR cooling-water passage (each passage part 44, 45, 48, and 49). Thus, the cooling water cooled in the radiator 32 can efficiently flow to the EGR cooler 24, thereby effectively cooling the EGR gas.

The present disclosure is not limited to the foregoing embodiments and may be appropriately modified or embodied in other specific forms without departing from the essential characteristics thereof.

(1) In each of the foregoing embodiments, the EGR cooling apparatus 41 is embodied by the gasoline engine system. As an alternative, the EGR cooling apparatus may be embodied by a diesel engine system.

(2) In each of the foregoing embodiments, the EGR cooling apparatus 41 is embodied by the gasoline engine system having no supercharger. As an alternative, the EGR cooling apparatus may be embodied by a gasoline engine system having a supercharger or a diesel engine system having a supercharger.

### INDUSTRIAL APPLICABILITY

The present disclosure is applicable to an EGR apparatus provided in an engine system equipped with an engine cooling device.

### REFERENCE SIGNS LIST

1 Engine
24 EGR cooler
31 Engine cooling device
32 Radiator
32a Water outlet
32b Water inlet
34 Engine-side water pump
35 Water jacket
35a Water outlet
35b Water inlet
36 Engine cooling water passage
41 EGR cooling apparatus
42 Radiator-side water pump
43 (First) Three-way valve
43a First port
43b Second port
43c Third port
44 First passage part
45 Second passage part
46 Third passage part
47 Fourth passage part
48 Fifth passage part
49 Sixth passage part
50 Second three-way valve
52 Engine water temperature sensor
54 Air flow meter
55 Intake-air temperature sensor
57 EGR water temperature sensor
60 ECU

What is claimed is:

1. An EGR cooling apparatus provided with an EGR cooler and configured to cause a cooling water that circulates through an engine cooling device for cooling an engine to flow to the EGR cooler to cool EGR gas flowing through the EGR cooler,
wherein the engine cooling device includes a radiator, an engine-side water pump, and an engine cooling water passage,
the engine cooling device is configured to operate the engine-side water pump to cause the cooling water to circulate through the engine cooling water passage via the engine, the radiator, and the engine-side water pump,
the engine, the radiator, and the EGR cooler each include a water inlet for inflow of the cooling water and a water outlet for outflow of the cooling water, and
the EGR cooling apparatus includes:
a first EGR cooling-water passage configured to allow the cooling water flowing out from the water outlet of the engine to the engine cooling water passage to return to the engine cooling water passage via the EGR cooler;
a second EGR cooling-water passage configured to allow the cooling water flowing out from the water outlet of the radiator to the engine cooling water passage to return to the engine cooling water passage via the EGR cooler;
a flow switching unit configured to switch a flow of the cooling water for the EGR cooler between the first EGR cooling-water passage and the second EGR cooling-water passage; and
a control unit configured to control the flow switching unit to switch the flow of the cooling water for the EGR cooler to the first EGR cooling-water passage when the engine is in a state during warm-up and switch the flow of the cooling water to the second EGR cooling-water passage when the engine is in a state after warm-up.

2. The EGR cooling apparatus according to claim 1, wherein
the flow switching unit includes a single three-way valve,
the control unit is configured to turn the three-way valve to an OFF state to cause the cooling water flowing out from the water outlet of the engine to the engine cooling water passage to flow through the first EGR cooling-water passage via the EGR cooler and the three-way valve and return to the engine cooling water passage near the engine-side water pump, and
the control unit is configured to turn the three-way valve to an ON state to cause the cooling water flowing out from the water outlet of the radiator to the engine cooling water passage to flow through the second EGR cooling-water passage via the three-way valve and the EGR cooler and return to the engine cooling water passage near the water outlet of the engine.

3. The EGR cooling apparatus according to claim 1, wherein
the flow switching unit includes a first three-way valve and a second three-way valve,
the control unit is configured to turn the first three-way valve and the second three-way valve to an OFF state to cause the cooling water flowing out from the water outlet of the engine to the engine cooling water passage to flow through the first EGR cooling-water passage via the second three-way valve, the EGR cooler, and the first three-way valve and return to the engine cooling water passage near the engine-side water pump, and
the control unit is configured to turn the first three-way valve and the second three-way valve to an ON state to cause the cooling water flowing out from the water outlet of the radiator to the engine cooling water passage to flow through the second EGR cooling-water passage via the first three-way valve, the EGR cooler, and the second three-way valve and return to the engine cooling water passage near the water inlet of the radiator.

4. The EGR cooling apparatus according to claim 1, further including a radiator-side water pump placed in the second EGR cooling-water passage, the radiator-side water pump being configured to pressure-feed the cooling water flowing out from the water outlet of the radiator to the EGR cooler,
wherein the control unit turns the radiator-side water pump to an ON state when a flow of the cooling water for the EGR cooler is switched to the second EGR cooling-water passage.

5. The EGR cooling apparatus according to claim 2, further including a radiator-side water pump placed in the second EGR cooling-water passage, the radiator-side water pump being configured to pressure-feed the cooling water flowing out from the water outlet of the radiator to the EGR cooler,
wherein the control unit turns the radiator-side water pump to an ON state when a flow of the cooling water for the EGR cooler is switched to the second EGR cooling-water passage.

6. The EGR cooling apparatus according to claim 3, further including a radiator-side water pump placed in the second EGR cooling-water passage, the radiator-side water pump being configured to pressure-feed the cooling water flowing out from the water outlet of the radiator to the EGR cooler,
wherein the control unit turns the radiator-side water pump to an ON state when a flow of the cooling water for the EGR cooler is switched to the second EGR cooling-water passage.

7. The EGR cooling apparatus according to claim 1, further including a warm-up state detecting unit to detect a warm-up state of the engine,
wherein the control unit determines whether the engine is in the state during warm-up or in the state after warm-up based on a detection result of the warm-up state detecting unit.

8. The EGR cooling apparatus according to claim 2, further including a warm-up state detecting unit to detect a warm-up state of the engine,
wherein the control unit determines whether the engine is in the state during warm-up or in the state after warm-up based on a detection result of the warm-up state detecting unit.

9. The EGR cooling apparatus according to claim 3, further including a warm-up state detecting unit to detect a warm-up state of the engine,
wherein the control unit determines whether the engine is in the state during warm-up or in the state after warm-up based on a detection result of the warm-up state detecting unit.

10. The EGR cooling apparatus according to claim 4, further including a warm-up state detecting unit to detect a warm-up state of the engine,
wherein the control unit determines whether the engine is in the state during warm-up or in the state after warm-up based on a detection result of the warm-up state detecting unit.

11. The EGR cooling apparatus according to claim 5, further including a warm-up state detecting unit to detect a warm-up state of the engine,
wherein the control unit determines whether the engine is in the state during warm-up or in the state after warm-up based on a detection result of the warm-up state detecting unit.

12. The EGR cooling apparatus according to claim 6, further including a warm-up state detecting unit to detect a warm-up state of the engine,
wherein the control unit determines whether the engine is in the state during warm-up or in the state after warm-up based on a detection result of the warm-up state detecting unit.
